(19) United States
(12) Patent Application Publication
(10) Pub. No.: US 2024/0353051 A1
(43) Pub. Date: Oct. 24, 2024

(54) Thermally Insulated Tubing for Geothermal Power Systems

(71) Applicant: Sage Geosystems Inc., Houston, TX (US)

(72) Inventors: Lev M. Ring, Bellaire, TX (US); Robert Lance Cook, Bellaire, TX (US)

(21) Appl. No.: 18/576,573

(22) PCT Filed: Jul. 8, 2022
(86) PCT No.: PCT/US2022/036552

§ 371 Date: Jan. 4, 2024

Related U.S. Application Data
(60) Provisional application No. 63/220,109, filed on Jul. 9, 2021.

(51) Int. Cl. F16L 59/15; F16L 59/02; F16L 59/065; F16L 59/147; F24T 10/00; F24T 10/20

(52) U.S. Cl. CPC F16L 59/15; F16L 59/028; F16L 59/065; F16L 59/147; F24T 10/20; F24T 2010/53

(57) ABSTRACT

A geothermal power system includes a power generation unit and tubing configured to be positioned within a wellbore coupled to the power generation unit. The tubing includes a first pipe with a first annular wall defining a first inner diameter and a first outer diameter. The first pipe has a first thermal conductivity. A second, pipe at least partially surrounds the first pipe. The second pipe includes a second annular wall defining a second inner diameter that is larger the first outer diameter of the first pipe. The second pipe has a second thermal conductivity. A coating applied to at least a portion of at least one of the first outer diameter of the first pipe and the second inner diameter of the second pipe has a coating thermal conductivity that is less than at least one of the first thermal conductivity and the second thermal conductivity.

### REFERENCE TO EARLIER FILED APPLICATIONS

The present application is the National Stage of International Application No. PCT/US2022/036552, filed Jul. 8, 2022, which in turn is an International Patent Application under the Patent Cooperation Treaty and claims priority to and the benefit of U.S. Provisional Patent Application Ser. No. 63/220,109 filed Jul. 9, 2022 and titled Thermally Insulated Tubing for Geothermal Power Systems, the disclosures of which are incorporated in their entirety by this reference.

### BACKGROUND

The present application relates to thermally insulated tubing for use in geothermal power systems.

Geothermal energy is a type of renewable energy generated within the earth. While it may be used directly for heating, it can also be transformed into electricity, typically through the use of surface turbines. Geothermal power produces relatively little carbon dioxide or other pollutants that contribute to global climate change and may reduce the reliance upon fossil fuels.

Historically, geothermal energy and production has centered around areas of the Earth with higher-than-normal temperature rocks are found relatively nearer to the surface. The regional nature of these resources limits the potential growth of geothermal power.

Further, the efficiency of geothermal power systems is directly a function of the amount of heat that can be transferred from below the Earth's surface—typically via a carrier medium, such as water and/or other fluids—and the change of temperature that carrier medium undergoes at the surface.

The thermal efficiency of present medium to low temperature (100° C.-200° C.) geothermal systems typically is less than 10 percent. In other words, less than 10 percent of the available heat energy is usefully converted into electricity.

The cost of producing geothermal power, then, could be significantly reduced and the ability to use medium to low temperature geothermal sources could be made available, if the efficiency of the entire geothermal power system is improved.

### BRIEF SUMMARY

An example of a geothermal power system includes a power generation unit. At least one tubing is configured to be positioned within a wellbore and coupled to the power generation unit. The at least one tubing includes at least a first pipe with a first annular wall, the first annular wall defining a first pipe inner diameter and a first pipe outer diameter, the at least a first pipe having a first thermal conductivity. The at least one tubing also includes at least a second pipe at least partially surrounding the at least a first pipe, the at least a second pipe including a second annular wall, the second annular wall defining a second inner diameter that is larger than the first pipe outer diameter of the at least a first pipe and that defines a trans-pipe annulus between the first pipe inner diameter and the first pipe outer diameter, the trans-pipe annulus having a trans-pipe distance, and a second outer diameter, the at least a second pipe having a second thermal conductivity. A coating may be applied to at least a portion of at least one of the first outer diameter of the at least a first pipe and the second inner diameter of the at least a second pipe, the coating having a coating thermal conductivity that is less than at least one of the first thermal conductivity and the second thermal conductivity.

The at least a first pipe may be expandable to increase at least one of the first pipe inner diameter and the first pipe outer diameter. Optionally, the first pipe outer diameter may be in at least partial contact with the second inner diameter.

The trans-pipe annulus may hold a vacuum along at least a portion of a length of the at least one tubing.

Optionally, the coating contacts the first pipe outer diameter of the at least a first pipe and the second inner diameter of the at least a second pipe along at least a portion of a length of the at least one tubing. A coefficient of thermal expansion of the coating may be proximate a coefficient of thermal expansion of at least one of the at least one first pipe and the at least one second pipe. The coating may include at least one ceramic particle. The ceramic particle may be composed of at least one of (a) yttria-stabilized zirconia, (b) alumina and silica, (c) alumina, (d) ceria, (c) ceria and yttria-stabilized zirconia, (f) rare-earth oxides, (g) rare-earth zirconates, (h) metal-glass composites, (i) at least one cenospheres, (j) at least one alumina-silica cenospheres, and (k) at least one alumina-silica cenosphere derived from fly ash.

Optionally, the geothermal power system further comprises at least one centralizer positioned about at least one of (a) the first pipe outer diameter of the at least a first pipe, (b) the coating, and (c) the second outer diameter of the at least a second pipe. Optionally, the at least one centralizer spans the trans-pipe annulus between at least one of (a) the first outer diameter of the at least a first pipe and the coating, (b) the coating and the second outer diameter of the at least a second pipe, and (c) the first outer diameter of the at least a first pipe and the second outer diameter of the at least a second pipe.

Optionally, the at least one tubing comprises a plurality of tubing. The at least a second pipe may include an up-hole connection and a downhole connection, and the downhole connection of the at least a second pipe may be connected to the up-hole connection of another second pipe positioned downhole of the at least a second pipe. The first pipe outer diameter of at least one first pipe may be radially proximate to the pipe connection. Optionally, at least one of the at least a first pipe and the at least a second pipe may be a metal.

Another example of a geothermal power system includes a power generation unit. At least one tubing is configured to be positioned within a wellbore and coupled to the power generation unit. The at least one tubing includes at least a first pipe with a first annular wall, the first annular wall defining a first pipe inner diameter and a first pipe outer diameter, the at least a first pipe having a first thermal conductivity. The at least one tubing also includes at least a second pipe at least partially surrounding the at least a first pipe, the at least a second pipe including a second annular wall, the second annular wall defining a second inner diameter that is larger than the first pipe outer diameter of the at least a first pipe and that defines a trans-pipe annulus between the first pipe inner diameter and the first pipe outer diameter, the trans-pipe annulus having a trans-pipe distance, and a second outer diameter, the at least a second pipe having a second thermal conductivity. A coating may be applied to at least a portion of at least one of the first outer diameter of the at least a first pipe and the second inner diameter of the at least a second pipe, the coating having a coating thermal conductivity that is less than at least one of the first thermal conductivity and the second thermal conductivity. The coating may include at least one ceramic particle composed of at least one of (a) yttria-stabilized zirconia, (b) alumina and silica, (c) alumina, (d) ceria, (c) ceria and yttria-stabilized zirconia, (f) rare-earth oxides, (g) rare-earth zirconates, (h) metal-glass composites, (i) at least one cenosphere, (j) at least one alumina-silica cenosphere, and (k) at least one alumina-silica cenosphere derived from fly ash.

Another example of a geothermal power system includes a power generation unit. At least one tubing is configured to be positioned within a wellbore and coupled to the power generation unit. The at least one tubing includes at least a first pipe with a first annular wall, the first annular wall defining a first pipe inner diameter and a first pipe outer diameter, the at least a first pipe having a first thermal conductivity. The at least one tubing also includes at least a second pipe at least partially surrounding the at least a first pipe, the at least a second pipe including a second annular wall, the second annular wall defining a second inner diameter that is larger than the first pipe outer diameter of the at least a first pipe and that defines a trans-pipe annulus between the first pipe inner diameter and the first pipe outer diameter, the trans-pipe annulus having a trans-pipe distance, and a second outer diameter, the at least a second pipe having a second thermal conductivity. A coating may be applied to at least a portion of at least one of the first outer diameter of the at least a first pipe and the second inner diameter of the at least a second pipe, the coating having a coating thermal conductivity that is less than at least one of the first thermal conductivity and the second thermal conductivity. The coating may include at least one ceramic particle composed of at least one of (a) yttria-stabilized zirconia, (b) alumina, (c) ceria, (d) ceria and yttria-stabilized zirconia, (c) rare-earth oxides, (f) rare-earth zirconates, (g) metal-glass composites, (h) at least one cenosphere, (i) at least one alumina-silica cenospheres, and (j) at least one alumina-silica cenosphere derived from fly ash.

Another example of a geothermal power system includes a power generation unit. At least one tubing is configured to be positioned within a wellbore and coupled to the power generation unit. The at least one tubing includes at least a first pipe with a first annular wall, the first annular wall defining a first pipe inner diameter and a first pipe outer diameter, the at least a first pipe having a first thermal conductivity. The at least a first pipe may be expanded to increase at least the first pipe inner diameter. The at least one tubing also includes at least a second pipe at least partially surrounding the at least a first pipe, the at least a second pipe including a second annular wall, the second annular wall defining a second inner diameter that is larger than the first pipe outer diameter of the at least a first pipe and that defines a trans-pipe annulus between the first pipe inner diameter and the first pipe outer diameter, the trans-pipe annulus having a trans-pipe distance, and a second outer diameter, the at least a second pipe having a second thermal conductivity. Optionally, the coating includes at least one ceramic particle composed of at least one of (a) yttria-stabilized zirconia, (b) alumina, (c) ceria, (d) ceria and yttria-stabilized zirconia, (e) rare-earth oxides, (f) rare-earth zirconates, (g) metal-glass composites, (h) at least one cenosphere, (i) at least one alumina-silica cenospheres, and (j) at least one alumina-silica cenosphere derived from fly ash.

An example of a method of manufacturing at least one tubing configured to be positioned within a wellbore and coupled to a power generation unit includes obtaining at least a first pipe with a first annular wall, the first annular wall defining a first inner diameter and a first outer diameter, the at least a first pipe having a first thermal conductivity and obtaining at least a second pipe, the at least a second pipe including a second annular wall, the second annular wall defining a second inner diameter that is larger the first outer diameter of the at least a first pipe, and a second outer diameter, the at least a second pipe having a second thermal conductivity. The method includes applying a coating to at least a portion of at least one of the first outer diameter of the at least a first pipe and the second inner diameter of the at least a second pipe, the coating having a coating thermal conductivity that is less than at least one of the first thermal conductivity and the second thermal conductivity. The method may further include positioning the at least a first pipe within the at least a second pipe such that the at least a second pipe at least partially surrounds the at least a first pipe so that the first pipe outer diameter of the at least a first pipe and the second inner diameter of the at least a second pipe defines a trans-pipe annulus with a trans-pipe distance.

The method optionally includes applying the coating using at least one of (a) electron beam physical vapor deposition, (b) air plasma spray, (c) high-velocity oxygen fuel, (d) electrostatic spray-assisted vapor deposition, and (e) direct vapor deposition.

The method optionally includes expanding at least one of the first pipe inner diameter and the first pipe outer diameter of the at least a first pipe. The method of expanding may include at least one of (a) drawing a mandrel through a first annulus of the at least a first pipe and (b) applying a hydrostatic force to the first pipe inner diameter of the at least a first pipe.

The method may further include positioning the at least one tubing in a wellbore and coupling the at least one tubing to the power generation unit.

The method may further include positioning at least one centralizer about at least one of (a) the first outer pipe diameter of the at least a first pipe, (b) the coating, and (c) the second outer diameter of the at least a second pipe.

The method, wherein the at least one second pipe includes an up-hole connection and a downhole connection, may further include connecting the downhole connection of the at least a second pipe to the up-hole connection of an another second pipe positioned downhole of the at least one second pipe. The method of connecting may occur at one of a surface and in the wellbore.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Various embodiments of the present inventions are set forth in the attached figures and in the Detailed Description as provided herein and as embodied by the claims. It should be understood, however, that this Summary does not contain all of the aspects and embodiments of the one or more present inventions, is not meant to be limiting or restrictive in any manner, and that the invention(s) as disclosed herein is/are and will be understood by those of ordinary skill in the art to encompass obvious improvements and modifications thereto.

Additional advantages of the present invention will become readily apparent from the following discussion, particularly when taken together with the accompanying drawings.

### BRIEF DESCRIPTION OF THE DRAWINGS

To further clarify the above and other advantages and features of the one or more present inventions, reference to specific embodiments thereof are illustrated in the appended drawings. The drawings depict only typical embodiments and are therefore not to be considered limiting. One or more embodiments will be described and explained with additional specificity and detail through the use of the accompanying drawings in which:

FIG. 1 is a geothermal power system coupled to an embodiment of the thermally insulated tubing.

FIG. 2 is a cutaway perspective view of a portion of an embodiment of the tubing.

FIGS. 3A and 3B are a cross-section view of an embodiment of the tubing.

FIG. 4 is a cross-section view of another embodiment of the tubing.

FIGS. 5A and 5B are a cross-section view of the tubing.

FIG. 6 and FIG. 7 are an embodiment of a method of expanding a first pipe.

Common element numbers represent common features, even if the appearance of a feature varies slightly between the figures.

The drawings are not necessarily to scale.

### DETAILED DESCRIPTION

The present invention will now be further described. In the following passages, different aspects of the embodiments of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

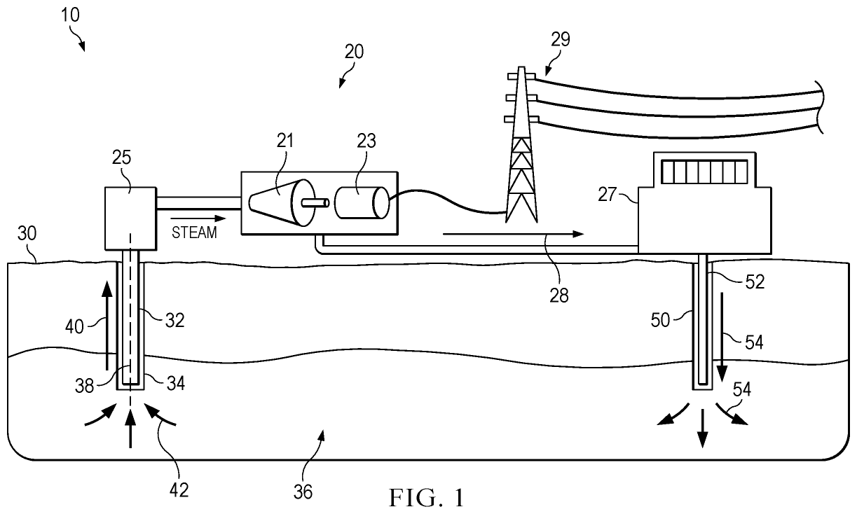

An idealized geothermal power system 10 includes a power generation unit 20 located on the Earth's surface 30 as illustrated in FIG. 1. The power generation unit 20 may be of any type that converts heat to electricity and may include any one or more of a turbine 21, generator 23, expansion unit 25, cooling unit 27 to receive the relatively cooler steam and/or water 28 from the turbine 21, and electricity transmission system 29. Some examples of representative power generation units include direct dry steam plants, flash plants, binary plants, combined-cycle or hybrid plants, and so forth, that receive heated fluid from surface or subsurface sources of heat.

The geothermal power system 10 also includes at least one tubing 32 that is configured to be positioned within a wellbore 34, the wellbore 34, in turn, being positioned in a subterranean geothermal source 36 or reservoir to return heated water or other heated working fluid 40 (including gases, liquids, and supercritical fluids such as supercritical carbon dioxide) that is heated via direct or indirect contact with any rock and/or fluid 42 in the geothermal source 36. Additionally, or alternatively, the at least one tubing 32 may be positioned within or along a source of heat on the surface. The at least one tubing is hydraulically coupled to the power generation unit 10. The at least one tubing includes a longitudinal axis 38.

The geothermal power system 10 optionally includes an injection well 50 and optionally at least one injection tubing 52 to inject cooled water or other working fluid (for example, supercritical carbon dioxide) 54 into the geothermal source 36.

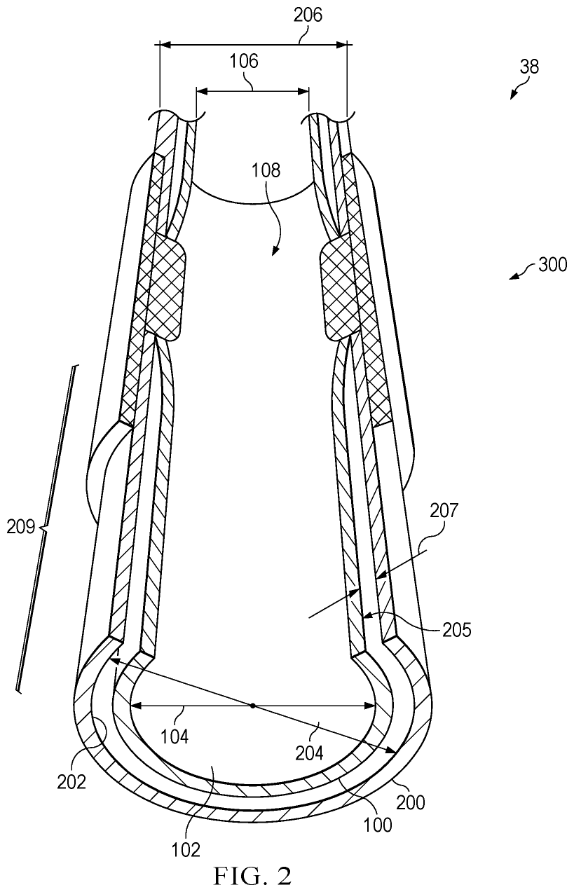

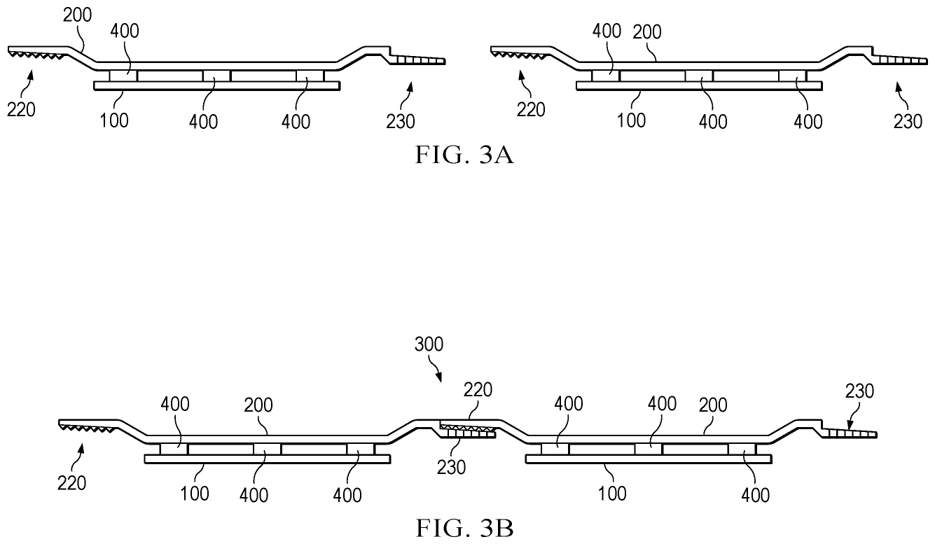

The at least one tubing 32, in turn, includes at least a first pipe 100 and at least a second pipe 200 surrounding the at least a first pipe 100 as illustrated in cutaway view in FIG. 2 and cross-section in FIGS. 3A and 3B.

The at least a first pipe 100 includes a first annular wall 102 that defines a first inner diameter 104 and a first outer diameter 106. The first pipe 100 is configured to transport fluids within the first pipe annulus 108 defined be first annular wall 102. The first pipe 100 includes a first thermal conductivity as commonly understood, namely the rate at which heat passes through the first annular wall 102.

Optionally, the first pipe 100 is expandable to increase at least one of the first inner diameter 104 and/or the first outer diameter 106 as will be discussed below.

The at least a second pipe 200 at least partially surrounds the at least a first pipe. FIG. 2 and FIG. 3. The second pipe includes a second annular wall 202 that defines a second inner diameter 204 that is larger than the first outer diameter 106 of the at least a first pipe 100. The distance between the first outer diameter 106 and the second inner diameter 204 defines a trans-pipe annulus 205. The trans-pipe annulus 205 has a trans-pipe distance 207. The trans-pipe annulus 205 optionally holds a vacuum along at least a portion 209 of a length of the at least one tubing 32. The at least a portion 209 may optionally be any subset of or the entire length of the at least one tubing 32. The second annular wall 202 also defines a second outer diameter 206 of the second pipe 200. The second pipe 200 has a second thermal conductivity that may be the same or different than the first thermal conductivity.

The first pipe 100 and the second pipe 200 may be formed of any typical material used for pipes, including metals (steel in all its alloys, nickel, non-magnetic metals), composites, fiberglass, carbon fiber, plastics, and the like.

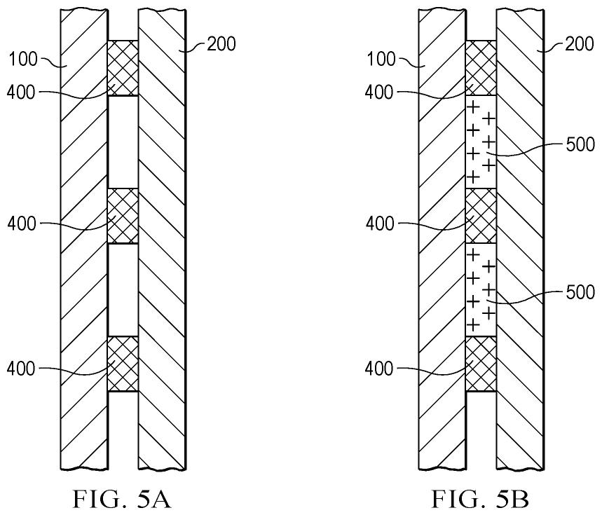

The first annular wall 102 optionally is in at least partial contact with the second annular wall 202 along a portion of the first outer diameter 106 and the second inner diameter 202, respectively, although the first outer diameter 106 could be completely separate from or completely in contact with the second inner diameter 202 with only a coating 500 (discussed below; FIG. 5B) separating the first outer diameter 106 and the second inner diameter 202.

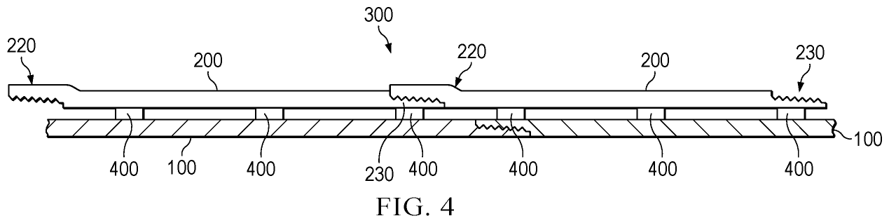

Optionally, the first pipe 100 and the second pipe 200 include a connection 300 at one or both of the uphole and the downhole end of the pipe. The connection(s) 300 allow for the first pipe 100 to be connected to another first pipe 100 or the second pipe 200 to be connected to another second pipe 200. The connection 300 may be welded, as illustrated in FIG. 2, bolted, or otherwise connected, or it may be a threaded connection, such as a threaded API connection as illustrated in FIGS. 3A, 3B, and 4. For example, an uphole connection 220 may be a box or female threaded connection and a downhole connection 230 may be a pin or male connection or vice-versa. For example, a downhole pin or male connection 230 of the second pipe 200 may be threaded or connected or coupled to the box or female connection of an adjacent or another second pipe 200 that is positioned downhole of the second pipe 200. FIG. 3B illustrates the second pipe 200 and the another second pipe 200 coupled together, from which it can be seen that in this example the first pipe 100 and the another first pipe 100 do not couple or connect, leaving the connection 300 uncovered, which is different from the covered and welded connection 300 in FIG. 2 and covered connection 300 illustrated in FIG. 4 in which the first pipe 100 is coupled to another first pipe 100 and expanded as discussed below.

Optionally, the outer diameter 106 of at least one first pipe 100 is radially proximate to the pipe connection.

The at least one tubing 32 includes a coating 500 (FIG. 5B) applied to at least a portion of at least one of the first outer diameter 106 of the at least a first pipe 100 and the second inner diameter 204 of the at least a second pipe 200. In other words, the coating 500 may be applied to just one or both of the first inner diameter 106 and the second inner diameter 204. The coating has a thermal conductivity that is less than at least one of the first thermal conductivity and the second thermal conductivity.

Optionally, a coefficient of thermal expansion of the coating 500 is proximate a coefficient of thermal expansion of at least one of the at least one first pipe 100, the at least one second pipe 200, and the centralizer 400 (discussed below). In this case, “proximate” is defined as being a coefficient of thermal expansion for the coating 500 that is +/−20% of the coefficient of thermal expansion of at least one of the at least one first pipe 100, the at least one second pipe 200, and the centralizer 400, and more preferably +/−10%, and more preferably still +/−5%.

Optionally, the coating 500 is chemically inert with respect to water, brine, hydrocarbons, carbon dioxide, ammonia, and the like.

Optionally, the coating 500 may be a mixture of multiple components and/or the coating 500 may include at least one layer and potentially a plurality of layers with each layer comprising the same or different materials, mixtures, and components.

The coating 500 optionally includes at least one ceramic material, ceramic particles, and/or combination of ceramic particles. The ceramic particles may be composed of at least one or more of the following in all of their chemical compounds or variations: (a) yttria-stabilized zirconia (YSZ), (b) alumina and silica (as a non-limiting example, mullite or 3Al₂O₃-2SiO₂), including alumina-silicate cenospheres (a hollow sphere filled with air and/or inert gas) and alumina-silicate cenospheres made from fly ash, (c) alumina (s a non-limiting example, α-phase Al₂O₃), (d) ceria (s a non-limiting example, CeO₂), (c) ceria and yttria-stabilized zirconia, (f) rare-earth oxides (s a non-limiting example, single and mixed phase materials comprising rare earth oxides, such as La₂O₃, Nb₂O₅, Pr₂O₃, CeO₂ as main phases, (g) rare-earth zirconates (s a non-limiting example, La₂Zr₂O₇, also referred to as LZ), and (h) metal-glass composites (s a non-limiting example, a powdered mixture of metal and glass). The ceramic particles may be any size such that when the ceramic particles are included in the coating 500 the coating 500 remains rheologically and thermally suitable for applying and adhering to at least one of the first pipe 100 and the second pipe 200. As one example, the ceramic particles, including, optionally, the alumina-silicate cenospheres, may be of any size, including the sub-50 micron range.

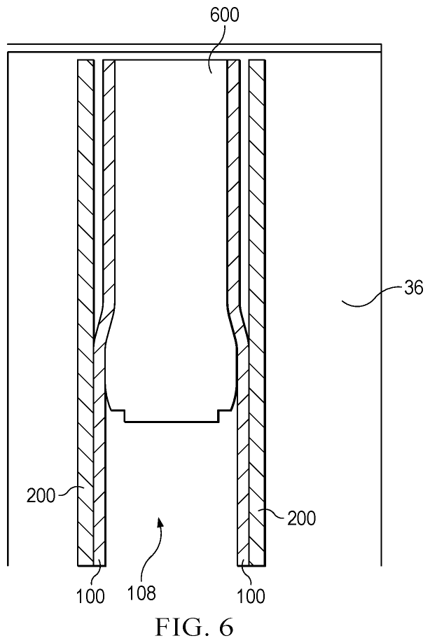

The coating 500 optionally includes a lubricant. The ceramic material and/or particles, particularly but not exclusively, the alumina-silicate cenospheres, may act as a lubricant when a mandrel 600 (FIG. 6) is drawn through a first annulus 108 of the at least a first pipe 100 to expand at least the inner diameter 104 of the at least a first pipe 100 as discussed below. The lubricant may reduce the hydraulic pressure or draw weight necessary to draw the mandrel 600 through the first annulus 108 relative to an uncoated first annulus 108 or a first annulus 108 that includes a coating 500 without a lubricant or ceramic material or ceramic particles.

The coating 500 optionally contacts the first outer diameter 106 of the at least a first pipe 100 and the second inner diameter 204 of the at least a second pipe 200 along at least a portion 209 of a length, which may be a subset or an entire length, of the at least one tubing 32. In other words, the coating 500 may span the trans-pipe distance 207 for a portion or the entire length of the tubing 32.

The coating 500 optionally includes a bond coat, such as a metallic bond coat or primer that helps the coating 500 adhere to the first pipe 100 and/or the second pipe 200. The bond coat may be an oxidation-resistant metallic layer. The bond coat may be a separate layer applied to at least the first pipe 100 and/or the second pipe 200 or it may be integral with the thermally insulative components of the coating 500. The bond coat is selected to adhere to the material of the first pipe 100 and/or the second pipe 200. The bond coat may be composed of at least one or more of the following in all of their chemical compounds or variations: an aluminum (Al), nickel (Ni), chromium (Cr), cobalt (Co), yttrium (Y), and/or platinum (Pt) alloys, such as NiCrAlY, NiCoCrAlY alloys, and other Ni and Pt aluminides.

The coating 500 also may optionally include a thermally-grown oxide (TGO) layer. The TGO layer typically is between the bond coat and the coating itself. The TGO layer may be formed of aluminum oxide (Al₂O₃). The TGO layer may be a separate layer applied or it may be integral with the thermally insulative components of the coating 500 and/or the bond coat.

At least one centralizer 400 may optionally be positioned about at least one of (a) the first outer diameter 106 of the at least a first pipe 100, (b) the coating 500, and (c) the second inner diameter 204 of the at least a second pipe 200, as illustrated in FIGS. 3A, 3B, 4, 5A, and 5B. (Not illustrated are optional centralizers that may be positioned about the second outer diameter 206 of the second pipe 200 that may at least partially or wholly span a distance between the second outer diameter 206 and the wellbore 34.) In some instances, the at least one centralizer 400 spans the trans-pipe annulus 205 between at least one of (a) the first outer diameter 106 of the at least a first pipe 100 and the coating 500, (b) the coating 500 and the second inner diameter 204 of the at least a second pipe 200, and (c) the first outer diameter 106 of the at least a first pipe 100 and the second inner diameter 204 of the at least a second pipe 200.

The centralizer 400 may be formed of any typical material, including metals (steel in all its alloys, nickel, non-magnetic metals), composites, fiberglass, carbon fiber, plastics, and the like.

The centralizer 400 may be formed of a low thermal conductivity material. In other words, the centralizer 400 may have a third thermal conductivity that may be less than one or more of the first thermal conductivity, the second thermal conductivity, and the thermal conductivity of the coating 500. The at least one centralizer 400 may be a plurality of centralizers, wherein each centralizer is spaced apart from an adjacent centralizer along the longitudinal axis 38 of the at least one tubing 32. The spacing of the one or more centralizers may be selected to ensure the at least first pipe 100 and the at least second pipe 200 satisfy any collapse or crush requirements for a depth and hydraulic pressure anticipated to be incurred by the tubing 32. The space between adjacent centralizers may be hold at least one of a vacuum, air, inert gas, or the coating 500.

Optionally, the geothermal system comprises a plurality of tubing made up of a plurality of the tubing components described above.

Methods of manufacturing the at least one tubing 32 include one or more of the following steps in any order.

A first pipe 100 and a second pipe 200 with the attributes described above are obtained.

The method also includes applying a coating 500 to at least a portion of at least one of the first outer diameter 106 of the at least a first pipe 100 and the second inner diameter 204 of the at least a second pipe 200. The coating 500 has a coating thermal conductivity that is less than at least one of the first thermal conductivity and the second thermal conductivity.

The method also includes positioning the at least a first pipe 100 within the at least a second pipe 200 such that the at least a second pipe 200 at least partially surrounds the at least a first pipe 100 and such that the first outer diameter 106 of the at least a first pipe 100 and the second inner diameter 204 of the at least a second pipe 200 defines a trans-pipe annulus 205 with a trans-pipe distance 207.

A plurality of tubing 32 may be coupled or connected together via the connections 300 described above and coupled to the power generation unit 10. The connecting or coupling of the each of the plurality of tubing 32 together optionally occurs at the surface or in the wellbore or a combination of the two.

The method also may include applying the coating 500 with one or more of the following processes: (a) electron beam physical vapor deposition, (b) air plasma spray, (c) high-velocity oxygen fuel, (d) electrostatic spray-assisted vapor deposition, and (e) direct vapor deposition.

The method also may include positioning at least one centralizer 400 about at least one of (a) the first outer diameter 106 of the at least a first pipe 100, (b) the coating 500, and (c) the second inner diameter 204 of the at least a second pipe 200.

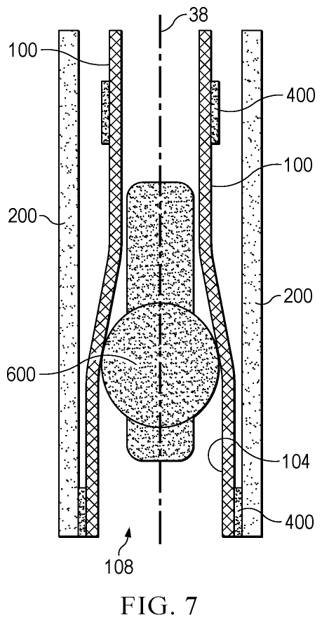

Optionally, the method includes expanding at least one of the first inner diameter 104 and the first outer diameter 106 of the at least a first pipe 100. The expanding step typically occurs after the first pipe 100 is positioned within the at least a second pipe 200, although the expanding step could occur before the first pipe 100 is positioned within the second pipe 200. The method of expanding optionally includes at least one of (a) drawing a mandrel 600 through a first pipe annulus 108 of the at least a first pipe as illustrated in FIG. 6 and (b) applying a hydrostatic force to the first inner diameter 104 of the at least a first pipe 100 as illustrated in FIG. 7 and as disclosed in U.S. Pat. No. 8,567,515, the disclosure of which is incorporated in full by this reference. An anticipated advantage of applying coatings of the type and characteristics disclosed above is that the coating likely will maintain its integrity as the at least first pipe is expanded. Stated differently, a coating applied to a component that changes in shape-such as its diameter or other dimension-typically will crack, flake, delaminate, detach from the component, in whole or in part, or otherwise suffer a failure of structural integrity. The coatings described will maintain its structural integrity—i.e., by applied area of the coating to at least one of the first outer pipe diameter and the second inner diameter, less than 20% of the total area, and, more preferably, less than 10% of the total area, and yet more preferably, less than 5% of the total area will suffer from at least one of cracking, flaking, delaminating, detaching, and/or other structural failure when the at least first pipe is expanded.

The method may further include positioning the at least one tubing 32 or a plurality of tubing in a wellbore 34 and coupling the at least one tubing 32 to the power generation unit 10.

The following numbered examples recite various elements and features of the application and may be combined in any order and/or combination. The following numbered examples are party of the original disclosure as filed.

### NUMBERED EXAMPLES

1. A geothermal power system, comprising:
a power generation unit;
at least one tubing configured to be positioned within a wellbore and coupled to the power generation unit that includes:
   at least a first pipe with a first annular wall, the first annular wall defining a first pipe inner diameter and a first pipe outer diameter, the at least a first pipe having a first thermal conductivity;
   at least a second pipe at least partially surrounding the at least a first pipe, the at least a second pipe including a second annular wall, the second annular wall defining a second inner diameter that is larger than the first pipe outer diameter of the at least a first pipe and that defines a trans-pipe annulus between the first pipe inner diameter and the first pipe outer diameter, the trans-pipe annulus having a trans-pipe distance, and a second outer diameter, the at least a second pipe having a second thermal conductivity; and,
   a coating applied to at least a portion of at least one of the first outer diameter of the at least a first pipe and the second inner diameter of the at least a second pipe, the coating having a coating thermal conductivity that is less than at least one of the first thermal conductivity and the second thermal conductivity.

2. The geothermal power system of claim 1, wherein the at least a first pipe is expandable to increase the first pipe inner diameter.

3. The geothermal power system of claim 1, wherein the first outer diameter is in at least partial contact with the second inner diameter.

4. The geothermal power system of claim 1, wherein the trans-pipe annulus holds a vacuum along at least a portion of a length of the at least one tubing.

5. The geothermal power system of claim 1, wherein the coating contacts the first outer diameter of the at least a first pipe and the second inner diameter of the at least a second pipe along at least a portion of a length of the at least one tubing.

6. The geothermal power system of claim 1, further comprising at least one centralizer positioned about at least one of (a) the first outer diameter of the at least a first pipe, (b) the coating, and (c) the second outer diameter of the at least a second pipe.

7. The geothermal power system of claim 6, wherein the at least one centralizer spans the trans-pipe annulus between at least one of (a) the first outer diameter of the at least a first pipe and the coating, (b) the coating and the second outer diameter of the at least a second pipe, and (c) the first outer diameter of the at least a first pipe and the second outer diameter of the at least a second pipe.

8. The geothermal power system of claim 1, wherein the at least one tubing comprises a plurality of tubing.

9. The geothermal power system of claim 8, wherein the at least a second pipe includes an up-hole connection and a downhole connection, and the downhole connection of the at least a second pipe is connected to the up-hole connection of another second pipe positioned downhole of the at least a second pipe.

10. The geothermal power system of claim 9, wherein the outer diameter of at least one first pipe is radially proximate to the pipe connection.

11. The geothermal power system of claim 1, wherein at least one of the at least a first pipe and the at least a second pipe is a metal.

12. The geothermal power system of claim 1, wherein a coefficient of thermal expansion of the coating is proximate a coefficient of thermal expansion of at least one of the at least one first pipe and the at least one second pipe.

13. The geothermal power system of claim 1, wherein the coating includes at least one ceramic particle.

14. The geothermal power system of claim 13, wherein the ceramic particle is composed of at least one of (a) yttria-stabilized zirconia, (b) alumina and silica, (c) alumina, (d) ceria, (e) ceria and yttria-stabilized zirconia, (f) rare-earth oxides, (g) rare-earth zirconates, (h) metal-glass composites, (i) at least one cenospheres, (j) at least one alumina-silica cenospheres, and (k) at least one alumina-silica cenosphere derived from fly ash.

15. A method of manufacturing at least one tubing configured to be positioned within a wellbore and coupled to a power generation unit, comprising:
obtaining at least a first pipe with a first annular wall, the first annular wall defining a first inner diameter and a first outer diameter, the at least a first pipe having a first thermal conductivity;
obtaining at least a second pipe, the at least a second pipe including a second annular wall, the second annular wall defining a second inner diameter that is larger the first outer diameter of the at least a first pipe, and a second outer diameter, the at least a second pipe having a second thermal conductivity;
applying a coating to at least a portion of at least one of the first outer diameter of the at least a first pipe and the second inner diameter of the at least a second pipe, the coating having a coating thermal conductivity that is less than at least one of the first thermal conductivity and the second thermal conductivity; and,
positioning the at least a first pipe within the at least a second pipe such that the at least a second pipe at least partially surrounds the at least a first pipe so that the first pipe outer diameter of the at least a first pipe and the second inner diameter of the at least a second pipe defines a trans-pipe annulus with a trans-pipe distance.

16. The method of claim 15, wherein applying a coating comprises using at least one of (a) electron beam physical vapor deposition, (b) air plasma spray, (c) high-velocity oxygen fuel, (d) electrostatic spray-assisted vapor deposition, and (e) direct vapor deposition.

17. The method of claim 15, further comprising expanding at least one of the first pipe inner diameter and the first pipe outer diameter of the at least a first pipe.

18. The method of claim 15, further comprising at least one of (a) drawing a mandrel through a first annulus of the at least a first pipe and (b) applying a hydrostatic force to the first pipe inner diameter of the at least a first pipe.

19. The method of claim 15, further comprising positioning the at least one tubing in a wellbore and coupling the at least one tubing to the power generation unit.

20. The method of claim 15, further comprising positioning at least one centralizer about at least one of (a) the first outer diameter of the at least a first pipe, (b) the coating, and (c) the second outer diameter of the at least a second pipe.

21. The method of claim 15, wherein the at least one second pipe includes an up-hole connection and a downhole connection, the method further comprising connecting the downhole connection of the at least a second pipe to the up-hole connection of an another second pipe positioned downhole of the at least one second pipe.

22. The method of claim 15, wherein the connecting occurs at one of a surface and in the wellbore.

23. A geothermal power system, comprising:
a power generation unit;
at least one tubing configured to be positioned within a wellbore and coupled to the power generation unit that includes:
   at least a first pipe with a first annular wall, the first annular wall defining a first pipe inner diameter and a first pipe outer diameter, the at least a first pipe having a first thermal conductivity;
   at least a second pipe at least partially surrounding the at least a first pipe, the at least a second pipe including a second annular wall, the second annular wall defining a second inner diameter that is larger than the first pipe outer diameter of the at least a first pipe and that defines a trans-pipe annulus between the first pipe inner diameter and the first pipe outer diameter, the trans-pipe annulus having a trans-pipe distance, and a second outer diameter, the at least a second pipe having a second thermal conductivity; and,
a coating applied to at least a portion of at least one of the first outer diameter of the at least a first pipe and the second inner diameter of the at least a second pipe, the coating having a coating thermal conductivity that is less than at least one of the first thermal conductivity and the second thermal conductivity, wherein the coating includes at least one ceramic particle composed of at least one of (a) yttria-stabilized zirconia, (b) alumina and silica, (c) alumina, (d) ceria, (e) ceria and yttria-stabilized zirconia, (f) rare-earth oxides, (g) rare-earth zirconates, (h) metal-glass composites, (i) at least one cenosphere, (j) at least one alumina-silica cenosphere, and (k) at least one alumina-silica cenosphere derived from fly ash.

24. A geothermal power system, comprising:
a power generation unit;
at least one tubing configured to be positioned within a wellbore and coupled to the power generation unit that includes:
   at least a first pipe with a first annular wall, the first annular wall defining a first pipe inner diameter and a first pipe outer diameter, the at least a first pipe having a first thermal conductivity;
   at least a second pipe at least partially surrounding the at least a first pipe, the at least a second pipe including a second annular wall, the second annular wall defining a second inner diameter that is larger than the first pipe outer diameter of the at least a first pipe and that defines a trans-pipe annulus between the first pipe inner diameter and the first pipe outer diameter, the trans-pipe annulus having a trans-pipe distance, and a second outer diameter, the at least a second pipe having a second thermal conductivity; and,
   a coating applied to at least a portion of at least one of the first outer diameter of the at least a first pipe and the second inner diameter of the at least a second pipe, the coating having a coating thermal conductivity that is less than at least one of the first thermal conductivity and the second thermal conductivity, wherein the coating includes at least one ceramic particle composed of at least one of (a) yttria-stabilized zirconia, (b) alumina, (c) ceria, (d) ceria and yttria-stabilized zirconia, (e) rare-earth oxides, (f) rare-earth zirconates, (g) metal-glass composites, (h) at least one cenosphere, (i) at least one alumina-silica cenospheres, and (j) at least one alumina-silica cenosphere derived from fly ash.

25. A geothermal power system, comprising:
a power generation unit;
at least one tubing configured to be positioned within a wellbore and coupled to the power generation unit that includes:
   at least a first pipe with a first annular wall, the first annular wall defining a first pipe inner diameter and a first pipe outer diameter, the at least a first pipe having a first thermal conductivity, wherein the at least a first pipe is expanded to increase at least the first pipe inner diameter;
   at least a second pipe at least partially surrounding the at least a first pipe, the at least a second pipe including a second annular wall, the second annular wall defining a second inner diameter that is larger than the first pipe outer diameter of the at least a first pipe and that defines a trans-pipe annulus between the first pipe inner diameter and the first pipe outer diameter, the trans-pipe annulus having a trans-pipe distance, and a second outer diameter, the at least a second pipe having a second thermal conductivity; and,
   a coating applied to at least a portion of at least one of the first pipe outer diameter of the at least a first pipe and the second inner diameter of the at least a second pipe, the coating having a coating thermal conductivity that is less than at least one of the first thermal conductivity and the second thermal conductivity.

26. The geothermal power system of claim 25, wherein the coating includes at least one ceramic particle composed of at least one of (a) yttria-stabilized zirconia, (b) alumina, (c) ceria, (d) ceria and yttria-stabilized zirconia, (e) rare-earth oxides, (f) rare-earth zirconates, (g) metal-glass composites, (h) at least one cenosphere, (i) at least one alumina-silica cenospheres, and (j) at least one alumina-silica cenosphere derived from fly ash.

The one or more present inventions, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure.

The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A geothermal power system, comprising:
a power generation unit;
at least one tubing configured to be positioned within a wellbore and coupled to the power generation unit that includes:
at least a first pipe with a first annular wall, the first annular wall defining a first pipe inner diameter and a first pipe outer diameter, the at least a first pipe having a first thermal conductivity;
at least a second pipe at least partially surrounding the at least a first pipe, the at least a second pipe including a second annular wall, the second annular wall defining a second inner diameter that is larger than the first pipe outer diameter of the at least a first pipe and that defines a trans-pipe annulus between the first pipe inner diameter and the first pipe outer diameter, the trans-pipe annulus having a trans-pipe distance, and a second outer diameter, the at least a second pipe having a second thermal conductivity; and,
a coating applied to at least a portion of at least one of the first pipe outer diameter of the at least a first pipe and the second inner diameter of the at least a second pipe, the coating having a coating thermal conductivity that is less than at least one of the first thermal conductivity and the second thermal conductivity;
wherein the coating includes at least one ceramic particle composed of at least one of (a) yttria-stabilized zirconia, (b) alumina and silica, (c) alumina, (d) ceria, (e) ceria and yttria-stabilized zirconia. (f) rare-earth oxides. (g) rare-earth zirconates, and (h) metal-glass composites.

2. The geothermal power system of claim 1, wherein the trans-pipe annulus holds a vacuum along at least a portion of a length of the at least one tubing.

3. The geothermal power system of claim 1, wherein the coating contacts the first pipe outer diameter of the at least a first pipe and the second inner diameter of the at least a second pipe along at least a portion of a length of the at least one tubing.

4. The geothermal power system of claim 1, further comprising at least one centralizer positioned about at least one of (a) the first pipe outer diameter of the at least a first pipe, (b) the coating, and (c) the second outer diameter of the at least a second pipe.

5. The geothermal power system of claim 4, wherein the at least one centralizer spans the trans-pipe annulus between at least one of (a) the first pipe outer diameter of the at least a first pipe and the coating, (b) the coating and the second outer diameter of the at least a second pipe, and (c) the first pipe outer diameter of the at least a first pipe and the second outer diameter of the at least a second pipe.

6. The geothermal power system of claim 1, wherein the at least one tubing comprises a plurality of tubing.

7. The geothermal power system of claim 1, wherein a coefficient of thermal expansion of the coating is proximate a coefficient of thermal expansion of at least one of the at least a first pipe and the at least a second pipe.

8. (canceled)

9. (canceled)

10. A method of manufacturing at least one tubing configured to be positioned within a wellbore and coupled to a power generation unit, comprising:
obtaining at least a first pipe with a first annular wall, the first annular wall defining a first pipe inner diameter and a first pipe outer diameter, the at least a first pipe having a first thermal conductivity;
obtaining at least a second pipe, the at least a second pipe including a second annular wall, the second annular wall defining a second inner diameter that is larger the first pipe outer diameter of the at least a first pipe, and a second outer diameter, the at least a second pipe having a second thermal conductivity;
applying a coating to at least a portion of at least one of the first pipe outer diameter of the at least a first pipe and the second inner diameter of the at least a second pipe, the coating having a coating thermal conductivity that is less than at least one of the first thermal conductivity and the second thermal conductivity, wherein the coating includes at least one ceramic particle composed of at least one of (a) yttria-stabilized zirconia. (b) alumina and silica, (c) alumina, (d) ceria, (e) ceria and yttria-stabilized zirconia, (f) rare-earth oxides, (g) rare-earth zirconates, and (h) metal-glass composites; and,
positioning the at least a first pipe within the at least a second pipe such that the at least a second pipe at least partially surrounds the at least a first pipe so that the first pipe outer diameter of the at least a first pipe and the second inner diameter of the at least a second pipe defines a trans-pipe annulus with a trans-pipe distance.

11. The method of claim 10, wherein applying a coating comprises using at least one of (a) electron beam physical vapor deposition, (b) air plasma spray, (c) high-velocity oxygen fuel, (d) electrostatic spray-assisted vapor deposition, and (e) direct vapor deposition.

12. The method of claim 10, further comprising expanding at least one of the first pipe inner diameter and the first pipe outer diameter of the at least a first pipe.

13. The method of claim 10, further comprising at least one of (a) drawing a mandrel through a first annulus of the at least a first pipe and (b) applying a hydrostatic force to the first pipe inner diameter of the at least a first pipe.

14. The method of claim 10, further comprising positioning the at least one tubing in a wellbore and coupling the at least one tubing to the power generation unit.

15. The method of claim 10, further comprising positioning at least one centralizer about at least one of (a) the first pipe outer diameter of the at least a first pipe, (b) the coating, and (c) the second outer diameter of the at least a second pipe.

16. The geothermal power system of claim 1, wherein the at least a first pipe is expandable to increase the first pipe inner diameter.

17. The geothermal power system of claim 1, wherein the first pipe outer diameter is in at least partial contact with the second inner diameter.

18. The geothermal power system of claim 6, wherein the at least a second pipe includes an up-hole connection and a downhole connection, and the downhole connection of the at least a second pipe is connected to the up-hole connection of another second pipe positioned downhole of the at least a second pipe.

19. The geothermal power system of claim 18, wherein the first pipe outer diameter of at least one first pipe is radially proximate to one of the up-hole connection and the downhole connection.

20. The geothermal power system of claim 1, wherein at least one of the at least a first pipe and the at least a second pipe is a metal.

21. A geothermal power system, comprising:
a power generation unit;
at least one tubing configured to be positioned within a wellbore and coupled to the power generation unit that includes:
at least a first pipe with a first annular wall, the first annular wall defining a first pipe inner diameter and a first pipe outer diameter, the at least a first pipe having a first thermal conductivity, wherein the at least a first pipe is expandable to increase at least the first pipe inner diameter;
at least a second pipe at least partially surrounding the at least a first pipe, the at least a second pipe including a second annular wall, the second annular wall defining a second inner diameter that is larger than the first pipe outer diameter of the at least a first pipe and that defines a trans-pipe annulus between the first pipe inner diameter and the first pipe outer diameter, the trans-pipe annulus having a trans-pipe distance, and a second outer diameter, the at least a second pipe having a second thermal conductivity; and,
a coating applied to at least a portion of at least one of the first pipe outer diameter of the at least a first pipe and the second inner diameter of the at least a second pipe, the coating having a coating thermal conductivity that is less than at least one of the first thermal conductivity and the second thermal conductivity.

22. The geothermal power system of claim 21, wherein the coating includes at least one ceramic particle composed of at least one of (a) yttria-stabilized zirconia, (b) alumina, (c) ceria, (d) ceria and yttria-stabilized zirconia, (e) rare-earth oxides, (f) rare-earth zirconates, (g) metal-glass composites, (h) at least one cenosphere, (i) at least one alumina-silica cenospheres, and (j) at least one alumina-silica cenosphere derived from fly ash.
